(19) United States
(12) Patent Application Publication
(10) Pub. No.: US 2010/0307679 A1
(43) Pub. Date: Dec. 9, 2010

(54) ADHESIVE FOR CORRUGATED CARDBOARD FOR PREVENTING PACKAGE STACK CRUMBLING AND METHOD OF PREVENTING PACKAGE STACK CRUMBLING WITH THE SAME

(75) Inventors: Shigemitsu Yotsumoto, Niiza-shi (JP); Toyohiko Fujii, Amagasaki-shi (JP)

Correspondence Address: SUGHRUE MION, PLLC, 2100 PENNSYLVANIA AVENUE, N.W., SUITE 800, WASHINGTON, DC, 20037, US

(73) Assignees: HIKARIBOND CO., LTD., Niiza-shi, Saitama (JP); KANAE CHEMICALS CO., LTD., Amagasaki-shi, Hyogo (JP); SHOWA HIGHPOLYMER CO., LTD., Minato-ku, Tokyo (JP)

(21) Appl. No.: 12/864,260

(22) PCT Filed: May 29, 2008
(86) PCT No.: PCT/JP2008/059914

§ 371 Date: Jul. 23, 2010

(30) Foreign Application Priority Data
Jan. 28, 2008 (JP) 2008-016678

(51) Int. Cl. B32B 37/12; C09J 101/00

(52) U.S. Cl. 156/299; 524/35; 156/328

(57) ABSTRACT

The present adhesive for corrugated cardboard for preventing package stack crumbling is characterized by comprising a mixture of a petroleum resin emulsion containing a mineral oil and a water-soluble resin solution. Examples of the water-soluble resin include polyvinyl alcohol, sodium polyacrylate, carboxymethyl cellulose, hydroxyethyl cellulose, etc. The adhesive for corrugated cardboard is effecting for preventing package stack crumbling within a short period of drying time, and does not damage the surfaces of the corrugated cardboard when unpacking the package stack.

### TECHNICAL FIELD

The present invention relates to an adhesive useful for preventing package stack crumbling of stacked corrugated cardboard boxes and the like, and a method for preventing package stack crumbling using the adhesive.

### BACKGROUND ART

In the field of logistics, in order to transport packages such as corrugated cardboard boxes and the like without package stack crumbling, the packages stacked on pallets or the like are shrink wrapped or stretch wrapped. However, the processes are not only troublesome when unpacking the package stacks, but discards of unneeded wrapping film materials after the unpackaging work become a big problem. The unpackaging work and discards increase the costs in the overall logistic systems.

Therefore, a method comprising temporarily bonding packages to each other with an adhesive, and a method comprising coating an antislipping agent on the surfaces of packages have been studied as a method for preventing package stack crumbling, which makes the unpackaging work easier and does not produce waste materials such as the wrapping film materials. As the adhesive used in the former method, an adhesive which comprises at least one type of vinyl polymer emulsion and vinyl copolymer emulsion was proposed (for example, see Patent Reference 1). As the antislipping agent used in the latter method, an antislipping agent which comprises a water dispersion containing colloidal silica having an average particle size of 9 nm or less, an organic polymer latex, and a water-dispersible or water-soluble polymer compound was proposed (for example, see Patent Reference 2).
Patent Reference 1: Japanese Patent Application Laid-open No. 6-207147
Patent Reference 2: Japanese Patent Application Laid-open No. 11-217535

### SUMMARY OF THE INVENTION

However, the inventors of the present application studied the matter, and found that when the adhesive described in Patent Reference 1 is used for corrugated cardboard, although the effect of preventing package stack crumbling is shown within a relatively short period of drying time, as the adhesive force is too strong after a certain period of drying time (for example, after 24 hours), the surface of the corrugated cardboard is damaged during unpackaging, and the appearance of the packages is remarkably damaged. In addition, they found that when the antislipping agent described in Patent Reference 2 is used for corrugated cardboard, the drying time required until the antislipping effect is exhibited is long, and the adhesion force is too strong after the antislipping agent has dried, in the same manner as the adhesive described in Patent Reference 1. Further, they found that when the adhesive and the antislipping agent are used diluted with water, not only are the effects of sufficiently preventing a package stack from crumbling not obtained, but also the time required for drying the adhesive and the antislipping agent is prolonged.

Accordingly, the object of the present invention is to provide an adhesive for preventing package stack crumbling which can show the effects preventing package stack crumbling within a short period of drying time, when used for corrugated cardboard, and does not damage the surface of the corrugated cardboard in the unpackaging work.

The inventors of the present application, after conducting intensive studies and development for solving the conventional problems described above, have found that the above problems can be solved by an adhesive obtained by mixing an emulsion composed of a specific component with a water-soluble resin solution, to complete the present invention.

Namely, the present invention is an adhesive for preventing package stack crumbling, characterized by comprising a mixture of a petroleum resin emulsion containing a mineral oil and a water-soluble resin solution.

The water-soluble resin is preferably at least one resin selected from the group consisting of polyvinyl alcohol, sodium polyacrylate, carboxymethylcellulose, and hydroxyethyl cellulose. The ratio by weight of the mineral oil to the petroleum resin in the petroleum resin emulsion is preferably 1:99 to 25:75. The mixing ratio of nonvolatile components in the petroleum resin emulsion is preferably 20 to 90 wt % with respect to all the nonvolatile components in the adhesive. In addition, the mixing ratio of the water-soluble resin is preferably 0.1 to 5 wt % with respect to the whole adhesive. The viscosity of the adhesive is preferably 50 to 10,000 mPa·s.

Further, the present invention relates to a method for preventing package stack crumbling of stacked corrugated cardboard boxes, comprising bonding the surfaces between the stacked corrugated cardboard boxes with the above adhesive for corrugated cardboard for preventing package stack crumbling.

Further, the present invention relates to a method for preventing package stack crumbling of stacked metal cans, comprising bonding the surfaces between the stacked metal cans by using a corrugated cardboard sheet coated with the above adhesive for corrugated cardboard for preventing package stack crumbling.

### EFFECTS OF THE INVENTION

According to the present invention, an adhesive which can show the effects of preventing package stack crumbling in a short period of drying time, when used for corrugated cardboard, and does not damage the surface of the corrugated cardboard in the unpackaging work can be provided.

### DETAILED DESCRIPTION OF THE INVENTION

The present invention will be specifically explained below.

The adhesive for corrugated cardboard for preventing package stack crumbling of the present invention can be obtained by mixing a petroleum resin emulsion containing a mineral oil with a water-soluble resin solution.

In the present invention, examples of the mineral oil include distillate oils obtained by distilling middle crude oil or naphthenic crude oil at atmospheric pressure, distillate oils obtained by distilling, under reduced pressure, residual oils formed in the atmospheric pressure distillation process, solvent-purified oils obtained by purifying this by a general technique, hydrorefined oils, dewaxed oils, purified oils such as white earth-purified oils and the like. They may be used alone or may be used in the form of a mixture of two or more thereof.

The petroleum resin in the present invention includes petroleum resins (petroleum-based hydrocarbon resins) such as aliphatic or C5 petroleum resins (copolymers comprising isoprene, piperylene, 2-methyl-1-butene, 2methyl-2-butene or the like as a main component), C9 petroleum resins (copolymers comprising styrene, vinyl toluene, α-methylstyrene, indene or the like as a main component), C5-C9 copolymer petroleum resins and the like. Among them, C5 petroleum resins are especially preferable. One portion of the petroleum resin may be substituted by a rosin-based resin in an amount within the range by which the effects of the present invention are not reduced.

The ratio by weight of the mineral oil to the petroleum resin in the petroleum resin emulsion is preferably in the range of 1:99 to 25:75, more preferably in the range of 3:97 to 20:80. If the mixing amount of the petroleum resin is too large, it is not preferable because there may be cases where an emulsifying step cannot be performed. If the mixing amount of the petroleum resin is too small, it is not preferable because there may be cases where the adhesion force is reduced, and the effects of preventing package stack crumbling cannot be sufficiently obtained.

The method for preparing the petroleum resin emulsion containing the mineral oil is not particularly limited. However, a method comprising dissolving the petroleum resin in the mineral oil, mixing them to form a water-in-oil emulsion using a dispersing agent, and adding inversion water to prepare an oil-in-water emulsion or the like may be used. Various publicly known surfactants, for example, nonionic surfactants, anionic surfactants, and cationic surfactants may be exemplified as the dispersing agents used for emulsifying and dispersing the petroleum resin. It is preferable that the nonvolatile components of the emulsion after the emulsifying and dispersing process should be optionally adjusted to 30 to 60 wt %.

The water-soluble resin solution in the present invention is prepared by dissolving a publicly known water-soluble resin including water-soluble cellulose derivatives such as methylcellulose, ethylcellulose, carboxymethylcellulose, hydroxyethyl cellulose, hydroxypropyl cellulose and the like, soluble starch, dextrin, polyvinyl alcohol, polyvinyl methyl ether, poly (meth) acrylic acid and salts thereof, polyvinyl pyrrolidone, polyacrylamide, sodium alginate and the like in water. Among these water-soluble resins, it is preferable to use at least one water-soluble resin selected from the group consisting of polyvinyl alcohol, sodium polyacrylate, carboxymethylcellulose, and hydroxyethyl cellulose.

The adhesive for corrugated cardboard for preventing package stack crumbling of the present invention can be produced by mixing the petroleum resin emulsion containing the mineral oil with the water-soluble resin solution by a publicly known method. The mixing ratio of the nonvolatile components in the petroleum resin emulsion is preferably 20 to 90 wt %, more preferably 30 to 80 wt % with respect to all the nonvolatile components in the adhesive. If the mixing amount of the nonvolatile components is too large, it is not preferable because there maybe cases where the adhesion force is reduced, and the effects of preventing package stack crumbling cannot be sufficiently obtained. If the mixing amount of the nonvolatile components is too small, it is not preferable because there maybe cases where the adhesion force is too strong, and the surface of the corrugated cardboard is damaged. In addition, the mixing ratio of the water-soluble resin solution is preferably 0.1 to 5 wt %, more preferably 0.2 to 2.0 wt % with respect to the whole adhesive. If the mixing amount of the water-soluble resin in the adhesive is too large, it is not preferable because there maybe cases where the adhesion force is too strong, and the surface of the corrugated cardboard is damaged. If the mixing amount of the water-soluble resin is too small, it is not preferable because there may be cases where the adhesion force is reduced, and the effects of preventing package stack crumbling cannot be sufficiently obtained. Considering ease in handling, permeability into corrugated cardboard, and drying properties, it is preferable that the viscosity of the adhesive for corrugated cardboard for preventing package stack crumbling of the present invention should be adjusted to 200 to 10, 000 mPa·s using the mixing ratios in the above preferable range. The viscosity values herein are the values determined by a B-type viscometer manufactured by of the adhesive for corrugated cardboard for preventing package stack crumbling of the present invention is generally within the range of 8.0 to 9.0.

Additives such as synthetic resin emulsions, fillers, anticorrosive agents, colorants, pH adjusting agents and the like may be added to the adhesive for corrugated cardboard for preventing package stack crumbling of the present invention in an amount by which the effects of the present invention are not reduced.

Next, the method for preventing package stack crumbling of the present invention will be explained.

According to the method for preventing package stack crumbling of the present invention, the package stack crumbling of stacked corrugated cardboard boxes or stacked metal cans can be prevented by using the above adhesive for corrugated cardboard.

More specifically, in order to prevent package stack crumbling of stacked corrugated cardboard boxes, the above adhesive for corrugated cardboard is coated on at least the top surface or bottom surface of each corrugated cardboard box, and the corrugated cardboard boxes are stacked such that a top surface contacts a bottom surface. By doing so, as the surfaces between the stacked corrugated cardboard boxes are bonded by the above adhesive for corrugated cardboard, package stack crumbling can be prevented.

When preventing the package stack crumbling of stacked metal cans, the above adhesive for corrugated cardboard is coated on a corrugated cardboard sheet having an appropriate size, and the metal cans are stacked such that the corrugated cardboard sheet is interposed between top surfaces and bottom surfaces of stacked metal cans. By doing so, as the surfaces between the stacked metal cans are bonded via the corrugated cardboard sheet coated with the above adhesive for corrugated cardboard, package stack crumbling can be prevented. In addition, when preventing the package stack crumbling of the stacked metal cans, it is only necessary to have a constitution in which the surfaces between the stacked metal cans are bonded via the corrugated cardboard sheet, and thus the adhesive for corrugated cardboard may be coated on the top surface and the bottom surface of the metal cans per se resulting in a similar constitution.

A method for coating the adhesive for corrugated cardboard for preventing package stack crumbling of the present invention is not particularly limited. Publicly known coating means such as brush painting, bar coaters, applicators, roll coaters, gravure coaters, dipping, spin coating, screen printing and the like may be used.

### Examples

### Example 1

To 980 g of ion-exchange water were added 4 g of hydroxyethyl cellulose and 6 g of sodium polyacrylate and mixed at 70° C. for one hour to dissolve the hydroxyethyl cellulose and sodium polyacrylate. After the mixture was cooled, 10 g of a petroleum resin emulsion containing a mineral oil (the ratio by weight of the mineral oil to the petroleum resin=5.9:94.1, 45% of the nonvolatile components) was added, and was mixed for 30 minutes to obtain the adhesive of Example 1. The obtained adhesive had a viscosity of 2,000 mPa·s and a pH of 8.7.

### Example 2

To 957 g of ion-exchange water was added 1 g of carboxymethylcellulose and mixed at 70° C. for one hour to dissolve the carboxymethylcellulose. After the mixture was cooled, 12 g of a polyvinyl alcohol solution containing 15 wt % of polyvinyl alcohol, and 30 g of a resin emulsion containing a mineral oil (the ratio by weight of the mineral oil: the petroleum resin:the rosin resin=7.4:85.2:7.4, 45% of the nonvolatile components) were added, and were mixed for 30 minutes to obtain the adhesive of Example 2. The obtained adhesive had a viscosity of 2,000 mPa·s and a pH of 8.4.

Package stack crumbling preventing performance was evaluated by the method below using the adhesives of Examples 1 and 2 , a commercially available agent for corrugated cardboard for preventing package stack crumbling, named FAST FIX (registered trademark) (manufactured by FAST CHEMICAL CO., LTD., product name FB6422LV-170, corresponding to the antislipping agent described in Patent Reference 2) as the adhesive used in Comparative Example 1, and a commercially available adhesive for preventing package stack crumbling, named VYNAL (a registered trademark) (manufactured by KANAE CHEMICALS CO., LTD., corresponding to the adhesive described in Patent Reference 1) as the adhesive used in Comparative Example 2.

### [Evaluation on Package Stack Crumbling Preventing Performance]

The adhesive was coated on portions in the vicinity of the four corners of the top surface of a 16 kg corrugated cardboard box (having a length of 325 mm, a width of 325 mm, and a height of 250 mm) by spot pointing using a brush, and two corrugated cardboard boxes were stacked on a wooden pallet so that the top surface of one corrugated cardboard box contacted the bottom surface of the other. After they were dried at 23° C. for 3 hours and 24 hours, the wooden pallet was inclined, and the angle at which the upper corrugated cardboard box was slid was measured. In addition, regarding the samples which had been dried for 24 hours, the unpackaging work was carried out after the measurement, and it was observed whether the surfaces of the corrugated cardboard boxes were damaged. The results thereof are shown in Table 1.

TABLE 1

| | Maximum inclined | | |
|---|---|---|---|
| | angle of samples | Samples after drying for 24 hours | |
| | after drying | Maximum | Presence |
| | for 3 hours | inclined angle | of damage |
| Example 1 | over 30° | over 30° | none |
| Example 2 | over 30° | over 30° | none |
| Comparative | 24° | over 30° | present |
| Example 1 | | | |
| Comparative | over 30° | over 30° | present |
| Example 2 | | | |

As is clear from the results in Table 1, the adhesives of Examples 1 and 2 were able to show the effects of preventing package stack crumbling after the drying process for three hours, and the surface of the corrugated cardboard was not damaged in the unpackaging work. On the other hand, Comparative Example 1 was not able to show the effects of sufficiently preventing package stack crumbling after the drying process for three hours. In addition, when either of the adhesives of Comparative Examples 1 and 2 was used, the surfaces of the corrugated cardboard boxes were damaged in the unpackaging work in the samples which had been dried for 24 hours.

Further, an adhesive was coated on both surfaces of corrugated cardboard sheets, and the sheets were put on two portions in the vicinity of opposing corners of the top surface of an 18 L can having a weight of 18 kg (having a length of 235 mm, a width of 235 mm, and a height of 355 mm). Another 18 L can was stacked thereon, and this was dried at 23° C. for two hours. Then, the wooden pallet was inclined in the same manner as in the evaluation using corrugated cardboard boxes to measure the inclined angle. Package stack crumbling of the samples using either of the adhesives did not occur until the inclined angle became 15°, but broken pieces of the corrugated cardboard sheets were attached to the cans in the samples using both of the adhesives of Comparative Examples 1 and 2 after the unpackaging work, and the broken pieces could not be easily removed.

1-8. (canceled)

9. An adhesive for corrugated cardboard for preventing package stack crumbling, characterized by comprising a mixture of a petroleum resin emulsion containing a mineral oil and a water-soluble resin solution.

10. An adhesive for corrugated cardboard for preventing package stack crumbling according to claim 9, wherein the water-soluble resin is at least one resin selected from the group consisting of polyvinyl alcohol, sodium polyacrylate, carboxymethylcellulose, and hydroxyethyl cellulose.

11. An adhesive for corrugated cardboard for preventing package stack crumbling according to claim 9, wherein the ratio by weight of the mineral oil to the petroleum resin is 1:99 to 25:75.

12. An adhesive for corrugated cardboard for preventing package stack crumbling according to claim 9, wherein the mixing ratio of nonvolatile components in the petroleum resin emulsion is 20 to 90 wt % with respect to all the nonvolatile components in the adhesive.

13. An adhesive for corrugated cardboard for preventing package stack crumbling according to claim 9, wherein the mixing ratio of the water-soluble resin is 0.1 to 5 wt % with respect to the whole adhesive.

14. An adhesive for corrugated cardboard for preventing package stack crumbling according to claim 9, wherein the viscosity of the adhesive is 50 to 10,000 mPa·s.

15. A method for preventing package stack crumbling of stacked corrugated cardboard boxes, comprising bonding the surfaces between the stacked cardboard boxes with the adhesive for corrugated cardboard for preventing package stack crumbling according to claim 9.

16. A method for preventing package stack crumbling of stacked metal cans, comprising bonding the surfaces between the stacked metal cans by using a corrugated cardboard sheet coated with the above adhesive for corrugated cardboard for preventing package stack crumbling according to claim 9.
